(19) United States
(12) Patent Application Publication
(10) Pub. No.: US 2005/0252949 A1
(43) Pub. Date: Nov. 17, 2005

(54) Method and device for welding rails with heat treated head using separate alloy additives

(76) Inventor: Rolf Plotz, Reichshof-Allenbach (DE)

Correspondence Address: Robert W Becker & Associates, Sutie B, 707 Highway 66 East, Tijeras, NM, 87059, US

(21) Appl. No.: 10/531,503

(22) PCT Filed: Oct. 11, 2003
(86) PCT No.: PCT/EP03/11282

§ 371 Date: Jul. 13, 2005

(30) Foreign Application Priority Data
Oct. 13, 2002 (DE) 102477515

(51) Int. Cl. B23K 28/00

(52) U.S. Cl. 228/196

(57) ABSTRACT

In a method and device for welding rails with a heat treated head, the halves of a casting mold made from a refractory material having at least one lateral vent are mounted around two end pieces of the rail that are to be connected, thereby forming a casting space. The mounting mold is preheated and the casting space is sealed by a sealing element made of refractory material covering the rail head; steel produced by a metallothermal process penetrates into the casting space after passing over the sealing element and fills the space, whereby alloy inserts in solid and compact form arranged above the rail head in the casting space are contacted with part of the steel forming the weld in the head zone.

The invention relates first to a method for welding rails with a heat treated head, in which the halves of a casting mold made from a refractory material having at least one lateral vent are mounted around two end pieces of the rail that are to be connected, thereby forming a casting space. The mounting mold is preheated and the casting space is sealed by a sealing element made of refractory material covering the rail head; steel produced by a metallothermal process penetrates into the casting space after passing over the sealing element and fills the space, whereby alloy additives in solid and compact form arranged above the rail head in the casting space are contacted with part of the steel forming the weld in the head zone.

DE 196 37 283 A1 discloses a method for aluminothermal intermediate casting welding of rails, whereby the aluminothermally produced steel is cast in a refractory casting mold which has an overflow and which surrounds the rail ends to be connected and alloy additives in a solid, compact form are brought into contact with a part of the steel running out from the reaction crucible, which forms the welding in the rail head region. In this manner, the alloy additives are arranged on a mold element (sealing element) mounted on a header in the upper region of the casting mold and covering the rail head. After completion of the aluminothermal reaction and separation of the steel from the slag according to requirements of a falling or rising casting, respectively, with falling or top casting with the latter or with rising or bottom casting with the former, steel flowing out of the reaction crucible is alloyed, whereby the overflow is closed. In other words, an overflow (bypass) is not provided and the alloy additives are disposed on the header and are first inserted into the mold after the preheating. The molds used in the known methods indeed have lateral vents, however, no inlet channels separated from the casting space. With top casting, the steel flows freely over the edges of the header into the upper part of the casting space; with a bottom casting, the steel running off from the header flows first into the flow gate and ascends then from below into the casting space.

It is an object of the present invention to provide a method of the above-described type, in which the alloying can take place in the head region by locating the alloy additives on the sealing element or header and a selective flow of the alloy region of the casting space can occur.

This object is solved in that before preheating, an alloy insert with a shape that enables the preheating of the rail ends is placed in the mold and the metallothermally, in particular aluminothermally, produced steel, after passing over the sealing element, penetrates into the casting space through sprues provided in each half mold and emerges into the casting space substantially in the area of the rail head.

By the separation of the alloy additives from the header or sealing element, they can be integrated into the mold during or directly after assembly. In addition, it is advantageous that they do not interfere with preheating after the integration. The sprues and their association to the head region provide a selective filling of the bar and foot region of the casting mold on the one hand and of the casting space section associated with the head region to be alloyed on the other hand.

The invention also relates to a device for welding rails with a heat treated head, in particular according to the method of claim 1, with a casting mold comprising two mold halves made of a refractory material, each having at least one lateral vent, which define a casting space upon assembly around the two rail ends to be connected, with a sealing element covering the rail head and closing the casting space and with alloy additives in a solid, compact form arranged above the rail head.

With the device of the present invention, it is provided that in both mold haves in the area of the casting space above the rail head, a bearing is provided, on which an alloy insert, having a shape that enables preheating of the rail ends to be connected, can be placed and that in each mold half, at least one sprue is provided, which opens in the region of the rail head into the casting space.

The dependent claims 3-10 are directed to advantageous embodiments of the device of the present invention.

The invention will be described next in greater detail with reference to the accompanying figures. In the drawings:

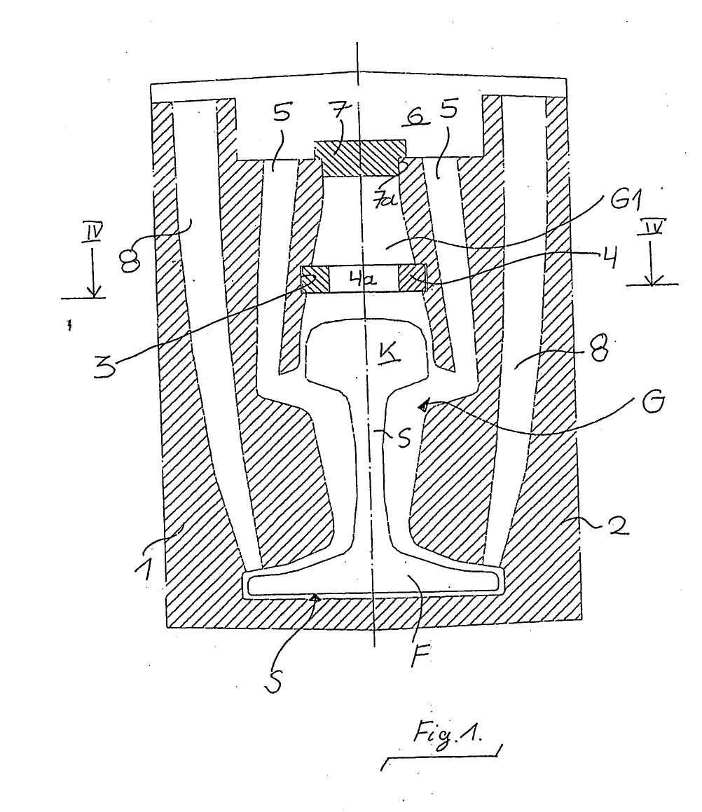

FIG. 1 shows a vertical section through a mold with a bearing groove above the rail head with a casting space tapering into the upper region without a bypass;

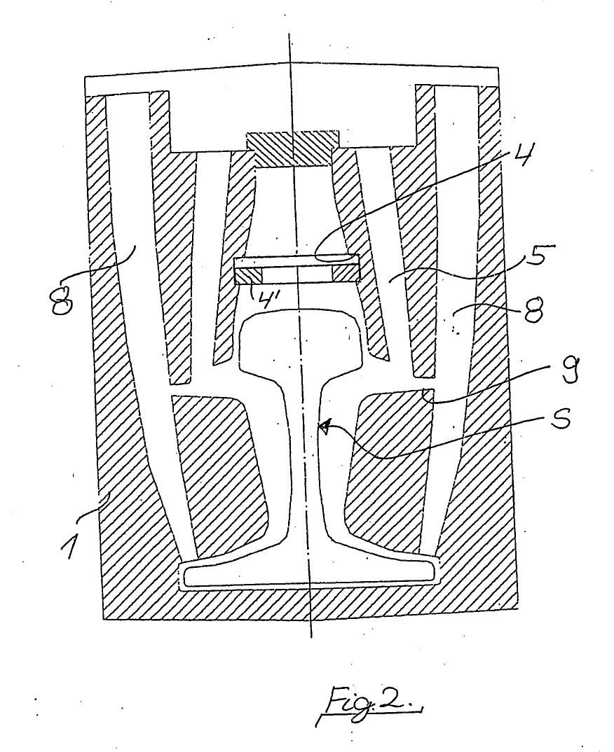

FIG. 2 shows a vertical section through a mold comparable to FIG. 1 with a thinner alloy insert in the bearing groove and with a bypass between the sprues and the lateral vents;

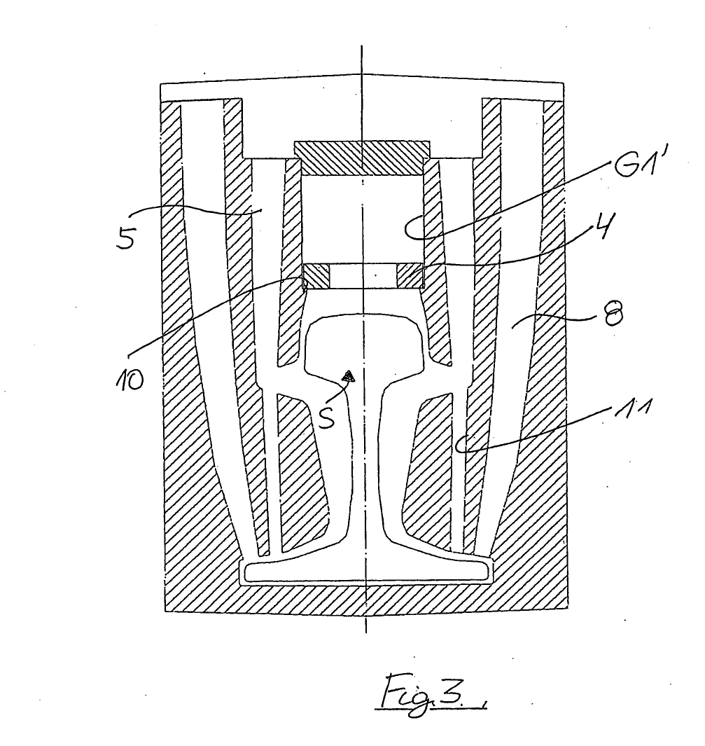

FIG. 3 shows a vertical section through a mold with a bearing step above the rail head with a casting space that does not taper into the upper region with a bypass between the sprues and the foot flanks;

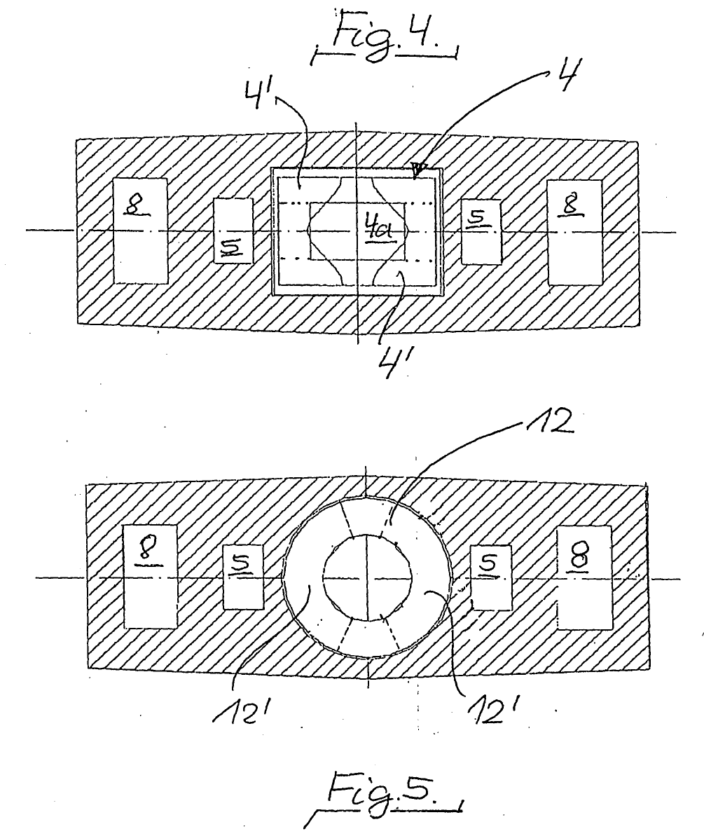

FIG. 4 shows a horizontal section through FIGS. 1-3 along the line IV-IV through a mold, in which the casting space has a rectangular cross section at least in the region of the bearing and thereabove; and

FIG. 5 shows a horizontal section through FIGS. 1-3 along line IV-IV through a mold, in which the casting space has a circular cross section at least in the region of the bearing and thereabove.

With the device shown in FIG. 1, two mold halves 1, 2 are mounted around the rail S with head K, bar S and foot F and define a casting space G surrounding the rail ends. The casting space G has a section G1 tapering out from the rail head K with a rectangular cross section (see FIG. 4), in which a circumferential bearing or support groove 3 is formed. During mounting of the two mold halves, a quadrilateral alloy insert 4 adapted to the dimensions of the groove and with a central opening 4a is placed in the bearing groove 3.

Sprues 5 are provided in the mold halves laterally near the section G1, which open to the lower end of the section G1 essentially in the area of the railhead K, and in the preferred manner, to the transition of the head to the bar S of the rails.

The upper ends of the sprues open to a distribution space 6 to which also the section G1 opens. The opening of the section G1 to the distribution space 6 can be closed by a bar-like sealing or closure element 7 having an engagement section 7a when the rail ends are to be preheated by means of a burner through the opening. The alloy insert 4, then, is inserted independently from the sealing element 7 into the mold and is preheated with the mold.

During the welding of the rails, steel contacting the sealing element 6 is distributed in the distribution space and flows from above into the sprues.

Provided in each of the mold halves is a lateral vent 8, which is placed essentially on the ends of the flanks of the foot F on the casting space G. The outlet opening of the lateral vent 8 lies above the inlet opening of the sprue 5.

With the embodiment of FIG. 2, a thinner alloy insert 4a is placed in the groove 3. This shows that an adaptation is possible depending on the desired head hardness.

In addition, a bypass 9 to the associated lateral vent 8 is provided at the lower end of the sprue 5. The bypass is represented with a horizontal gradient. However, it also can run diagonally or more vertically. This is also true for bypasses, which can be provided in addition to the one.

With the embodiment of FIG. 3, a step 10 is provided in section G1′ as the bearing or support. Above the step 10, the section G1′ has a constant cross section, so that the alloy insert 4 also can be placed around the rails after assembly of the two mold halves.

In addition, a bypass 11 to the casting space G is provided at the lower end of the sprue 5 in the area of the flanks of the rail foot F. The bypass is represented with a vertical gradient. It also can have a diagonal orientation. This is true also for bypasses, which can be provided in addition to the one.

The structure of the bearing can be exchanged in FIGS. 2 and 3. Under certain conditions, also a combination of the bypasses 9 and 11 is contemplated.

FIG. 4 shows with dotted lines that also individual bars 4′ can be used as alloy inserts instead of the one-piece, quadrilateral plate 4 with the central opening 4a. The individual bars 4′ are placed in the groove, such that they do not impair preheating.

FIG. 5 shows a circular cross section of the casting space above the rail head in the area of the bearing in the form of the groove 3 or the step 9. A circular ring or circular ring parts that do not necessarily form a complete circle can be used as the alloy insert 12 (see parts 12′ in FIG. 5). For adapting to the head curing, it is also contemplated that multiple circular rings can be placed over one another with the embodiment of the bearing as a step after assembly of the mold halves.

The invention thus offers the possibility for adapting to different head curing jobs with one or multi-part alloy inserts or with multiple one-part alloy inserts, whereby the alloy inserts or alloy insert parts also can have a different configuration.

1-10. (canceled)

11. A method for welding rails with heat-treated heads, comprising the following step:
providing a casting mold made of a refractory material and having two mold halves, wherein each mold half has at least one lateral vent and at least one sprue;
mounting the two mold halves around two end pieces of the rail that are to be connected, thereby forming a casting space;
inserting an alloy insert into the casting mold, wherein the alloy insert has a shape that enables to preheating of the end pieces of the rail;
preheating the mounting mold;
sealing the casting space with a sealing element made of refractory material covering the rail head;
introducing steel produced by a metallothermal process into the casting space through the sprues in the mold halves after passing over the sealing element, thereby filling the casting space, wherein said steel emerges into the casting space substantially at the rail head; and
contacting alloy inserts in solid and compact form arranged above the rail head in the casting space with part of the steel forming a weld in a region of the rail head.

12. A device for welding rails with heat treaded heads, comprising:
a casting mold comprising two mold halves made from a refractory material each having at least one lateral vent, wherein said two mold halves, upon assembly around two rails ends that are to be connected, define a casting space;
a sealing element covering the rail head and sealing the casting space;
alloy inserts in solid and compact form arranged above the rail head, wherein in both mold halves in an area of the casting space above the rail head, a bearing is provided, wherein an alloy insert with a shape making it possible to preheat end pieces of the rail can be placed on the bearing, and wherein in each mold half, at least one sprue is provided, wherein the at least one sprue opens in a region of the rail head into the casting space.

13. The device of claim 12, wherein the bearing is formed by a circumferential groove, such that the alloy insert can be inserted during the mold assembly

14. The device of claim 12, wherein the bearing is formed by a circumferential step, such that the alloy insert can be inserted after the mold assembly.

15. The device of claim 12, wherein the casting space has a quadratic cross section at least in the area of the bearing, and wherein the alloy insert comprises at least one bar.

16. The device of claim 12, wherein the alloy insert comprises at least one quadrilateral element with a central opening.

17. The device of claim 12, wherein the casting space has a circular cross section at least in the area of the bearing, and wherein the alloy insert comprises at least one graduated ring.

18. The device of claim 17, wherein the alloy insert comprises a circular ring.

19. The device of claim 12, wherein each mold half has at least one bypass from the sprue to the lateral vent.

20. The device of claim 12, wherein each mold half has at least one bypass from the sprue to the casting space in the region offoot flanks of the rails.
